(19) United States
(12) Patent Application Publication
(10) Pub. No.: US 2025/0147467 A1
(43) Pub. Date: May 8, 2025

(54) HOROLOGICAL MOVEMENT COMPRISING A SETTING AND WINDING MECHANISM WITH AN INTERNAL STOP FOR POSITIONING A WINDING STEM

(71) Applicant: Blancpain SA, Le Brassus (CH)

(72) Inventor: Alain DELIZÉE, Les Bioux (CH)

(73) Assignee: Blancpain SA, Le Brassus (CH)

(21) Appl. No.: 18/811,882

(22) Filed: Aug. 22, 2024

(30) Foreign Application Priority Data
Sep. 29, 2023 (EP) 23200831.8

(51) Int. Cl. G04B 27/04

(52) U.S. Cl. CPC G04B 27/04

(57) ABSTRACT

A horological movement including a mechanism for setting and winding the horological movement, the setting and winding mechanism including a winding stem with an axis of revolution (X), having a first end cooperating with a winding button and a second end opposite the winding button, the winding stem being movable rotatably and translatably along the axis of revolution (X) between a first axial position (T1) of the winding stem in which the rotation of the winding stem winds the horological movement, and a second axial position (T2) of the winding stem in which the rotation of the winding stem sets a function of the horological movement, wherein the setting and winding mechanism includes a positioning stop configured to cooperate, by contact, with the second end of the winding stem to stop the winding stem axially in the first axial position (T1).

### TECHNICAL FIELD

The invention relates to a horological movement comprising a mechanism for setting and winding such a movement.

For example, the invention can be applied to a wristwatch comprising a mechanical movement.

More particularly, the invention relates to a mechanism for winding and setting a horological movement, which mechanism can assume various positions in order to carry out and set different functions of the horological movement.

### TECHNOLOGICAL BACKGROUND

A mechanical watch is typically set and wound by means of a winding button that can be operated by the user by rotation and pulling. This winding button is typically located in the 3 o'clock position on the circumference of the watch. The winding button is integral with a winding stem which can be moved axially, along its axis of revolution, between a plurality of axial positions corresponding to each function to be operated by the horological movement, such as manual winding of the movement, setting the time, setting the date, and setting other indicators that move above or beneath the dial of the watch.

Conventionally, the manual winding position of the movement corresponds to the axial position of the winding stem in which it is retracted the furthest into the movement. This winding position corresponds to the neutral position of the winding stem, typically referred to as the T1 position.

An example embodiment of a setting and winding mechanism 1 for a horological movement according to the prior art is shown in FIG. 1, with the winding stem 2 in the winding position.

In this winding position, the winding pinion 3 is driven by the sliding pinion 6, which rotates as one with the winding stem 2 when the latter rotates. The winding pinion 3 meshes with a winding crown-wheel (not shown) forming a 90° gearing. This 90° gearing is particularly sensitive and the slightest deviation in the positioning of the winding stem 2, and thus in the distance between the winding pinion 3 and the winding crown-wheel, can have adverse consequences on these components, such as premature wear of the toothing.

Thus, a known technique to ensure that the toothing does not mesh against the root surfaces during winding is that of adding an external stop 4 to the winding stem 2. Such an external stop 4 forms a collar which comes into an abutting contact with the outside of the plate 5, at a support cone or support surface provided for this purpose.

However, in certain configurations, this solution involves machining a support cone on the outer transverse flank of the plate 5 to abuttingly receive and house the stop 4 of the winding stem 2.

This solution also requires the collar/cone support plane to be checked, and corrected if necessary, according to the chain of tolerances of the various parts, to ensure that the support occurs at the correct distance from the centre of the horological movement, and thus that the winding pinion 3 gears correctly with the winding button.

Lastly, this solution results in contact between the steel winding stem 2 and the brass plate 5, which causes the contact surface to deteriorate with each load, generating filings.

As a result, there is a need to improve horological movements comprising setting and winding mechanisms in order to address at least one of these issues.

### SUMMARY OF THE INVENTION

The invention aims to solve at least one of the above problems.

To this end, the invention proposes a horological movement comprising a mechanism for setting and winding said horological movement, the setting and winding mechanism comprising a winding stem with an axis of revolution, having a first end cooperating with a winding button and a second end opposite the winding button, said winding stem being movable rotatably and translatably along the axis of revolution between a first axial position T1 of the winding stem in which a rotation of the winding stem winds the horological movement, and a second axial position T2 of the winding stem in which a rotation of the winding stem sets a function of the horological movement, characterised in that the setting and winding mechanism comprises a positioning stop configured to cooperate, by contact, with said second end of the winding stem to stop said winding stem axially in said first axial position T1.

In particular, this type of architecture makes it easier to design and manufacture a horological movement, by eliminating the need to create a support surface on the outer transverse flank of the plate.

According to the invention, the use of a positioning stop internal to the horological movement makes it easier to control its position and the chain of tolerances of the various parts. This type of architecture ensures optimum gearing of the various components of the setting and winding mechanism of the horological movement, particularly between the winding pinion of the winding stem and the winding crown-wheel.

Preferably, the positioning stop extends perpendicularly relative to a general plane formed by a pull-out piece jumper comprised in the setting and winding mechanism, or relative to a general plane formed by a bridge or by a plate comprised in the horological movement.

Preferably, the positioning stop is integral with the bridge, the plate or the pull-out piece jumper.

Preferably, the positioning stop is a pin, a stud or a screw.

Preferably, the positioning stop is the shaft about which a moving part of the horological movement pivots.

Preferably, the moving part is configured to mesh with a sliding pinion carried by the winding stem when the latter is positioned in said second axial position T2.

Preferably, the moving part is an intermediate wheel for the minute wheel.

Preferably, the horological movement comprises a motion-work train cooperating with the intermediate wheel for the minute wheel.

Preferably, the positioning stop is made of metal with a hardness equivalent to or greater than that of the winding stem. Preferably, the positioning stop is made of steel, advantageously a steel identical to the steel used for the winding stem. This avoids the problem of filings being generated by contact with the winding stem.

The invention further relates to a timepiece, for example a wristwatch, comprising a horological movement according to the invention.

### BRIEF DESCRIPTION OF THE FIGURES

The invention will be described in more detail hereafter using the accompanying drawings, given by way of examples that are in no way limiting, wherein:

FIG. 1, already described, shows a perspective view of a setting and winding mechanism for a timepiece according to the prior art;

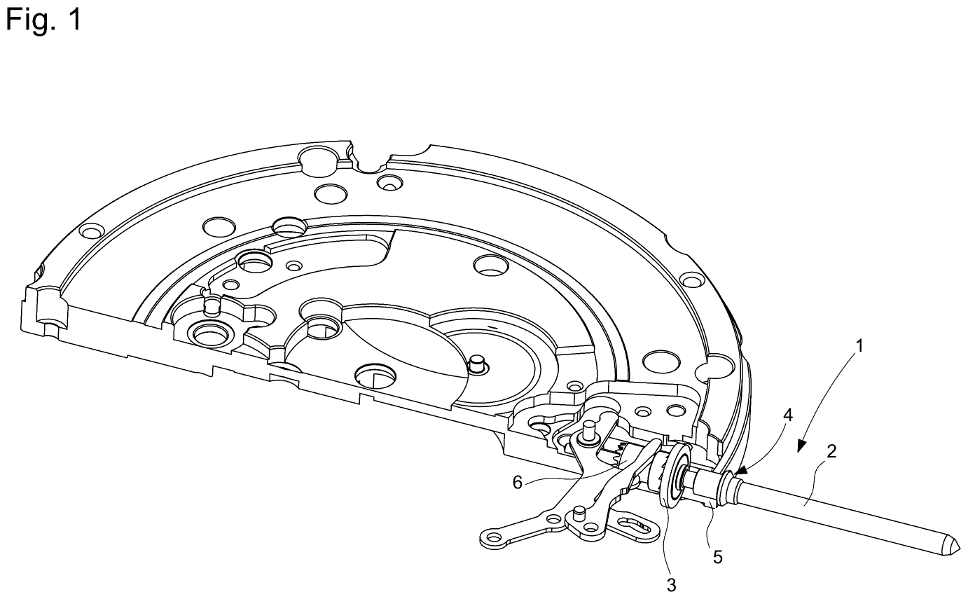

FIG. 2 shows a perspective view from above of a first example embodiment of a mechanism for setting and winding a horological movement according to the invention, in a first axial position T1 corresponding to the winding position of the horological movement;

FIG. 3 shows a perspective view of the first example embodiment of the setting and winding mechanism of a horological movement illustrated in FIG. 2, in a second axial position T2 corresponding to a first setting position of the horological movement;

FIG. 4 shows a perspective view from below of the first example embodiment of a mechanism for setting and winding a horological movement illustrated in FIG. 2, in the first axial position T1 corresponding to the winding position of the horological movement;

FIG. 5 shows a perspective view of a second example embodiment of a mechanism for setting and winding a horological movement according to the invention, in a first axial position T1 corresponding to the winding position of the horological movement;

FIG. 6 diagrammatically shows a timepiece comprising a horological movement equipped with a setting and winding mechanism according to the invention.

In all the figures, common elements bear the same reference numerals unless specified to the contrary.

### DETAILED DESCRIPTION OF THE INVENTION

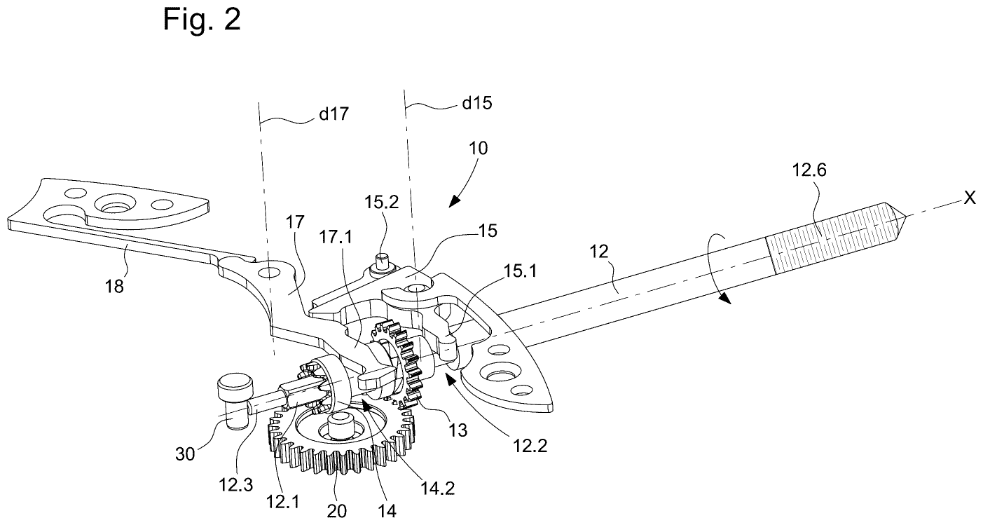

FIG. 2 to 4 illustrate a horological movement 100 comprising a setting and winding mechanism 10 according to the invention.

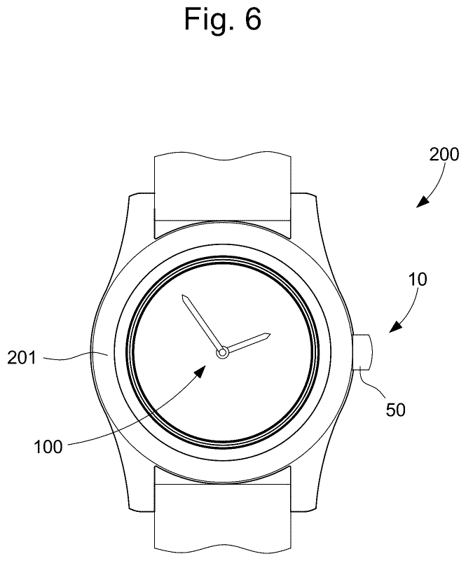

FIG. 6 shows a timepiece 200 comprising a horological movement 100 equipped with a setting and winding mechanism 10 according to the invention.

The horological movement 100 can be a mechanical movement, but it can also be an electronic or electromechanical horological movement known in the prior art.

The entire setting and winding mechanism 10 is supported by a plate (not shown) of the horological movement 100 or from the plate via stationary elements or bridges fastened by ad-hoc means to the plate.

The setting and winding mechanism 10 comprises a winding stem 12, of axis of revolution X, typically having, at a first end, a threaded part 12.6 configured to receive a winding button 50 that can be handled by the user outside the case 201 of the timepiece 200.

The winding stem 12 comprises a winding pinion 13 and a sliding pinion 14, also referred to as a sliding gear, mounted so as to slide along the X axis on a square section 12.1 of the winding stem 12, to which it is rigidly connected, via its square central orifice, for rotation therewith.

The setting and winding mechanism 10 comprises a pull-out piece 15, pivotally mounted on the plate along a pull-out piece pivot axis d15. The pull-out piece 15 comprises a stud 15.1 engaged and housed in an annular groove 12.2 in the winding stem 12. The pull-out piece 15 transmits the axial movements of the winding stem 12, along the axis X, to the sliding pinion 14 via a lever 17, pivotally mounted on the plate about a lever pivot axis d17, and guided by the pivoting movements of the pull-out piece 15.

The sliding pinion 14 has a central annular groove 14.2 configured to receive and house a portion 17.1 of the lever 17, so that the lever 17 imposes its movements on the sliding pinion 14.

A resilient lever member 18 cooperates with the lever 17 so as to exert a resilient force on the lever 17 working to reposition the sliding pinion 14 towards the winding pinion 13.

In the horological movement 100, the winding stem 12 is rotatable about its axis of revolution X and axially displaceable along this axis of revolution X, between different axial positions corresponding to different functions of the horological movement 100 of the timepiece 200, such as manually winding the movement, setting the time, setting the date and/or setting other indicators that move above or beneath the dial of the timepiece 200.

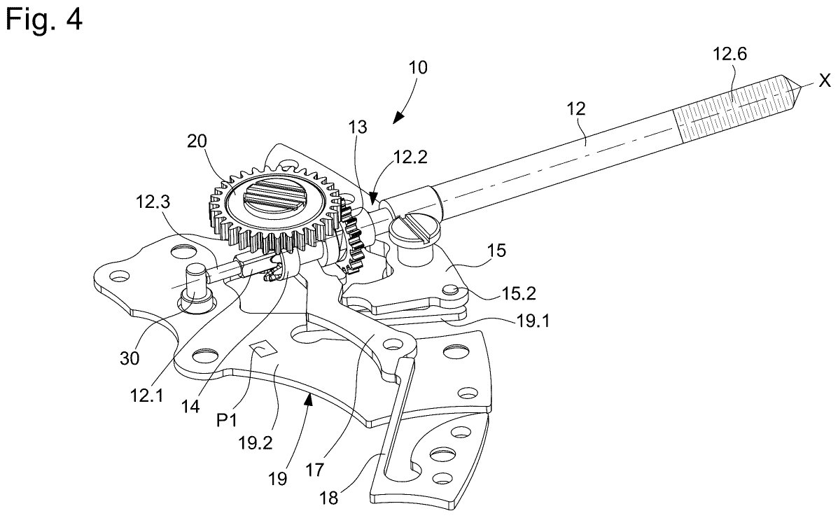

The setting and winding mechanism 10 comprises a pull-out piece jumper 19 (visible in FIG. 4) which typically takes the form of a plate with a general plane P1, having a stationary portion 19.2 forming a main body, configured to be integral with the plate, and a jumper spring 19.1, forming a moving portion, cooperating with a pull-out piece pin 15.2 carried by the pull-out piece 15.

The pull-out piece jumper 19 acts as a bridge for holding various elements of the setting and winding mechanism 10.

The jumper spring 19.1 has a profile with one or more notches in which the pull-out piece pin 15.2 engages to index the position of the pull-out piece 15, and as a result the winding stem 12, in the various axial positions to define stable setting positions for the various functions of the horological movement 100.

FIG. 2 shows in particular the setting and winding mechanism 10 in the winding position of the horological movement 100, referred to as the first axial position T1. In this first axial position T1, the winding stem 12 is retracted as far as possible into the case 201 and into the horological movement 100.

In this first axial position T1, the sliding pinion 14 meshes with the winding pinion 13 which meshes with a winding crown-wheel 20 making 90° gearing. In this first axial position T1 of the winding stem 12, rotation thereof thus causes the winding crown-wheel 20 to rotate.

Conventionally, the winding crown-wheel 20 is connected to the ratchet fastened to the barrel arbor, so that rotation of the winding stem 12 causes the mainspring to be wound. This first axial position T1 corresponds to the winding position of the horological movement 100 or the winding position of the spring.

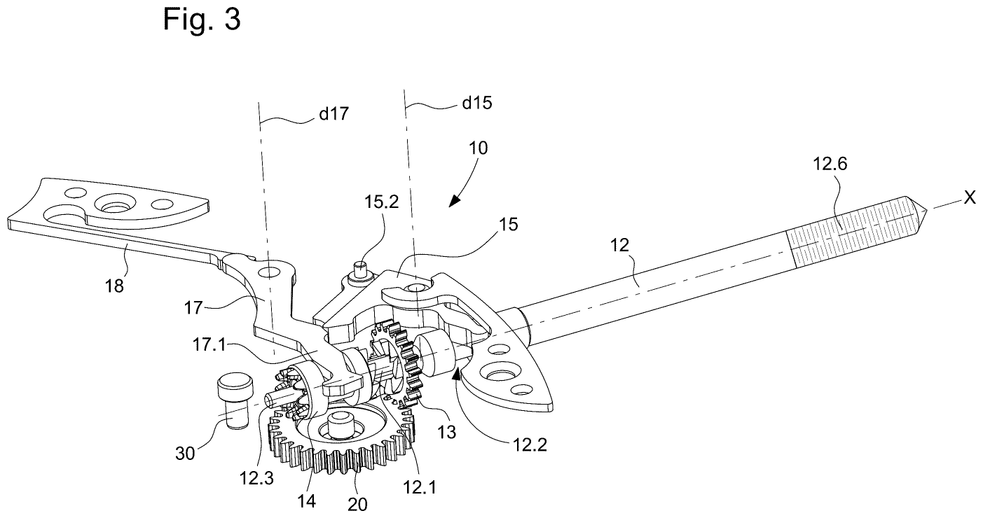

FIG. 3 shows the setting and winding mechanism 10 in a second axial position T2 which is a setting position of the horological movement, for example a time setting position. To reach this second axial position T2, the user pulls axially on the winding button 50 to move the winding stem 12 axially along the axis of revolution X towards the outside of the plate and of the case 201 of the timepiece 200.

By pulling on the winding stem 12, the pull-out piece 15 pivots and repels the lever (which pivots in the direction of the horological movement 100) by sliding the sliding pinion 14 along the square 12.1 of the winding stem 12. The sliding pinion 14 disengages from the winding pinion 13 and meshes with an intermediate wheel (not shown) which is connected, for example, to the minute wheel and the hour pipe when this second axial position T2 corresponds to a time setting position of the timepiece movement 100. In this second axial position T2, the pull-out piece pin 15.2 is engaged in a lower notch of the jumper spring 19.1 than when it is in the first axial position T1.

It goes without saying that, on from the second axial position T2, a third, or even a fourth, axial position can be provided, which positions correspond to positions for setting a function of the horological movement, by pulling the winding stem 12 further towards the outside of the plate, or of the case 201, in order to set other functions such as, for example, a date, and/or another complication of the horological movement 100.

The number of axial setting or control positions of the horological movement 100 is not defined and can vary from a single position to any number achievable for a specific horological movement.

When the winding stem 12 is pushed back towards the plate, the various members return to the various positions illustrated and described above with reference to FIG. 2.

To ensure correct positioning of the winding stem 12 when the latter is pushed back into the first axial position T1, the setting and winding mechanism 10 comprises a positioning stop 30 positioned inside the horological movement 100 in opposition to a positioning stop located on the periphery of the horological movement 100 and outside the plate.

The positioning stop 30 is intended to prevent the winding stem 12 from moving when it is pushed back into the horological movement 100.

More particularly, the positioning stop 30 is positioned perpendicular to the axis of movement of the winding stem 12 (in this case the X axis), so that a second end 12.3 of the winding stem 12, opposite the winding button 50 and forming the inner end of the winding stem 12, comes into contact with the positioning stop 30 when the winding stem 12 is brought into the first axial position T1.

Thus, positioning a positioning stop 30 facing the inner end 12.3 of the winding stem 12 so that the latter comes into abutting contact in the first axial position T1 ensures optimum meshing of the winding pinion 13 with the winding crown-wheel 20, without contact with the root surfaces of the toothing, since the winding stem 12 cannot be in a more retracted axial position. The meshing is thus optimal and meshing wear is minimised.

The positioning stop 30 is integral with the plate, a bridge or, as shown in FIG. 4, the pull-out piece jumper 19, which is integral with the plate acting as a bridge. Thus, the positioning stop 30 is easy to position and its position relative to the centre of the horological movement 100 is easily controllable and repeatable.

Thus, such a positioning stop makes it possible to control the chain of dimensions between the winding stem 12, the winding pinion 13, the positioning stop 30, the plate and the pull-piece jumper 19 so as to guarantee optimum meshing of the winding pinion 13 with the winding crown-wheel 20 in the first axial position T1 of the winding stem 12.

The positioning stop 30 extends perpendicularly relative to the general plane of the plate, of a bridge or of the pull-out piece jumper 19, so as to form a stop to the movement of the winding stem 12.

The positioning stop 30 is, for example, a pin, a stud, a screw or a shaft about which a moving part pivots.

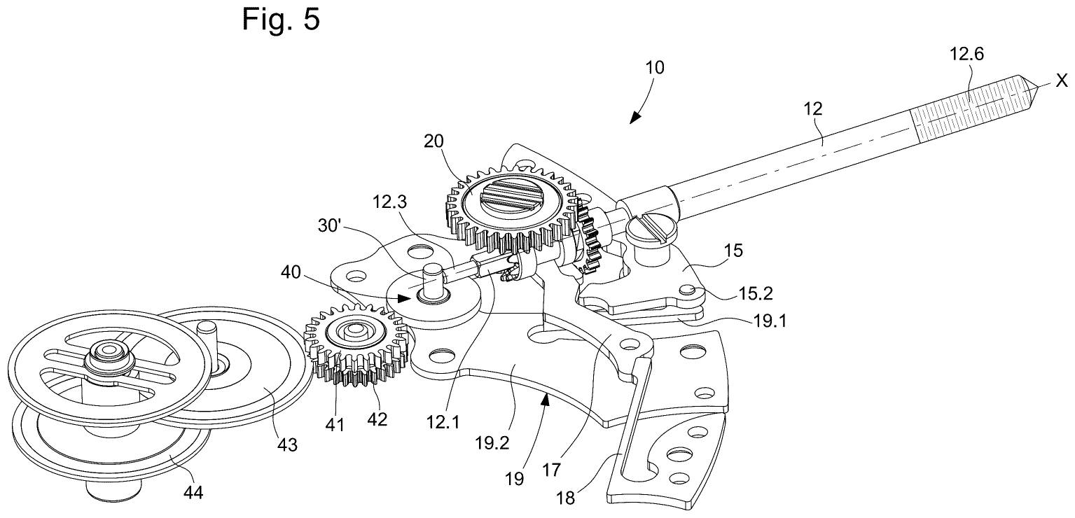

FIG. 5 illustrates a second example embodiment of a setting and winding mechanism according to the invention. This second example embodiment is identical to the first example embodiment described with reference to FIG. 2 to 4, with the exception of the features which will be explained below with reference to this FIG. 5.

In this second example embodiment illustrated in FIG. 5, the intermediate wheel 40 for the minute wheel of the horological movement 100 is positioned so that its shaft about which the intermediate wheel 40 for the minute wheel pivots constitutes the positioning stop 30′ of the winding stem 12, as previously mentioned with reference to FIG. 2 to 4.

In this configuration, it is advantageous to use the stationary shaft of the intermediate wheel 40 for the minute wheel to form the positioning stop 30′ and to stop the axial displacement of the winding stem 12 when it returns to its first axial position T1. Preferably, the shaft of the intermediate wheel 40 for the minute wheel is mounted integrally on a bridge or the plate.

In the second axial position T2 of the winding stem 12, the sliding pinion 14 meshes with the intermediate wheel 40 for the minute wheel which cooperates with a motion-work train of the horological movement 100.

More specifically, the intermediate wheel 40 for the minute wheel meshes with a first intermediate wheel 41 which rotates as one with a second intermediate wheel 42 which meshes with a minute wheel 43.

The minute wheel 43 rotates as one with a minute pinion which meshes with an hour pipe 44 carrying an hour hand.

The invention is advantageously applicable to mechanical horological movements with manual winding, but it is also applicable to electronic watches of the quartz or other type, in particular electronic watches comprising analogue display members.

The materials used for the various components are preferably metals.

The positioning stop 30, 30′ is advantageously made of steel or of a metal with the same hardness as the winding stem 12.

1. A horological movement comprising a mechanism for setting and winding said horological movement, the setting and winding mechanism comprising a winding stem with an axis of revolution X, having a first end cooperating with a winding button, and a second end opposite the winding button, said winding stem being movable rotatably and translatably along the axis of revolution X between a first axial position of the winding stem in which a rotation of the winding stem winds the horological movement, and a second axial position of the winding stem in which a rotation of the winding stem sets a function of the horological movement, wherein the setting and winding mechanism comprises a positioning stop configured to cooperate, by contact, with said second end of the winding stem to stop said winding stem axially in said first axial position.

2. The horological movement according to claim 1, wherein said positioning stop extends perpendicularly relative to a general plane P1 formed by a pull-out piece jumper comprised in the setting and winding mechanism, or relative to a general plane formed by a bridge or by a plate comprised in the horological movement.

3. The horological movement according to claim 2, wherein said positioning stop is integral with said bridge, said plate or the pull-out piece jumper.

4. The horological movement according to claim 1, wherein said positioning stop is a pin, a stud or a screw.

5. The horological movement according to claim 1, wherein said positioning stop is the shaft about which a moving part of the horological movement pivots.

6. The horological movement according to claim 5, wherein said moving part is configured to mesh with a sliding pinion carried by the winding stem when the latter is positioned in said second axial position.

7. The horological movement according to claim 5, wherein said moving part is an intermediate wheel for the minute wheel.

8. The horological movement according to claim 7, wherein it comprises a motion-work train cooperating with the intermediate wheel for the minute wheel.

9. The horological movement according to claim 1, wherein said positioning stop is made of steel.

10. A timepiece comprising a horological movement according to claim 1.
